(19) United States
(12) Patent Application Publication
(10) Pub. No.: US 2017/0351546 A1
(43) Pub. Date: Dec. 7, 2017

(54) RESOURCE PREDICTORS INDICATIVE OF PREDICTED RESOURCE USAGE

(71) Applicant: Hewlett Packard Enterprise Development LP, Houston, TX (US)

(72) Inventors: Karim Habak, Palo Alto, CA (US); Shruti Sanadhya, Palo Alto, CA (US); Daniel George Gelb, Redwood City, CA (US); Kyu-Han Kim, Palo Alto, CA (US)

(21) Appl. No.: 15/539,234

(22) PCT Filed: Dec. 23, 2014
(86) PCT No.: PCT/US14/72054

§ 371 Date: Jun. 23, 2017

(51) Int. Cl. G06F 9/50

(52) U.S. Cl. CPC G06F 9/505; G06F 9/5038; G06F 2209/509; G06F 2209/5019

(57) ABSTRACT

An example device in accordance with an aspect of the present disclosure includes a launch engine and an offload engine. The launch engine is to request a resource predictor based on analysis of collected resource usage information. The offload engine is to compare resource availability at the device to predicted resource usage indicated in the resource predictor, and offload at least a portion of resource usage.

### BACKGROUND

Mobile devices are increasingly capable computing platforms, having processor power, memory and network interfaces. This increased capability has led to the deployment on handheld mobile devices of resource intensive applications, such as online/offline complex games, image processing, body language interpretation, and natural language processing. Despite the capability of smartphones, some issues, such as battery life and other constraints, may be more limiting compared to other capabilities expected by today's applications.

### BRIEF DESCRIPTION OF THE DRAWINGS/FIGURES

FIG. 1 is a block diagram of a device including a launch engine and an offload engine according to an example.

FIG. 2 is a block diagram of a device including a request engine and a predictor engine according to an example.

FIG. 3 is a block diagram of a client device and a server device according to an example.

FIG. 4 is a block diagram of a plurality of client devices and a cloud engine according to an example.

FIG. 5 is a flow chart based on offloading resource usage according to an example.

FIG. 6 is a flow chart based on offloading resource usage according to an example.

FIG. 7 is a flow chart based on building resource predictor(s) according to an example.

### DETAILED DESCRIPTION

Application resource usage may exceed the capabilities of a mobile device. Outside assistance may be used to acceptably run such applications, including computational offloading to seamlessly assist mobile devices while executing resource intensive tasks. Application profiling is important to the success of offloading systems. Examples described herein are capable of providing universal, complete, and efficient application profiles, coupled with an accurate resource-usage prediction mechanism based on these application profiles, e.g., collecting resource usage information and/or generating resource predictors. Thus, examples described herein are not limited to processor consumption based on a fixed set of inputs, and therefore may characterize application behavior and needs in much greater detail to address other types of resource usage. For example, processing, networking, memory, and other resource usage may be offloaded from example devices to the cloud or to other devices (e.g., devices in the same network or in proximity). Application profiling similarly may address multiple types of resource usage, and is not limited to execution time on a specific device. Application profiling is not limited to static code analysis or a need for a training period, and may capture real-world usage by real users, going beyond mere random inputs.

Examples described herein enable accurate profiling of applications by monitoring not just their processor (e.g., compute; central processing unit (CPU)) resource usage, but also other resource usage such as network, memory, and/or disk input/output (I/O) usage. An application profiler may use crowd-sourced information, and may combine application performance information from multiple devices to form an accurate prediction of resource usage footprints for given applications. Examples also may use machine-learning techniques.

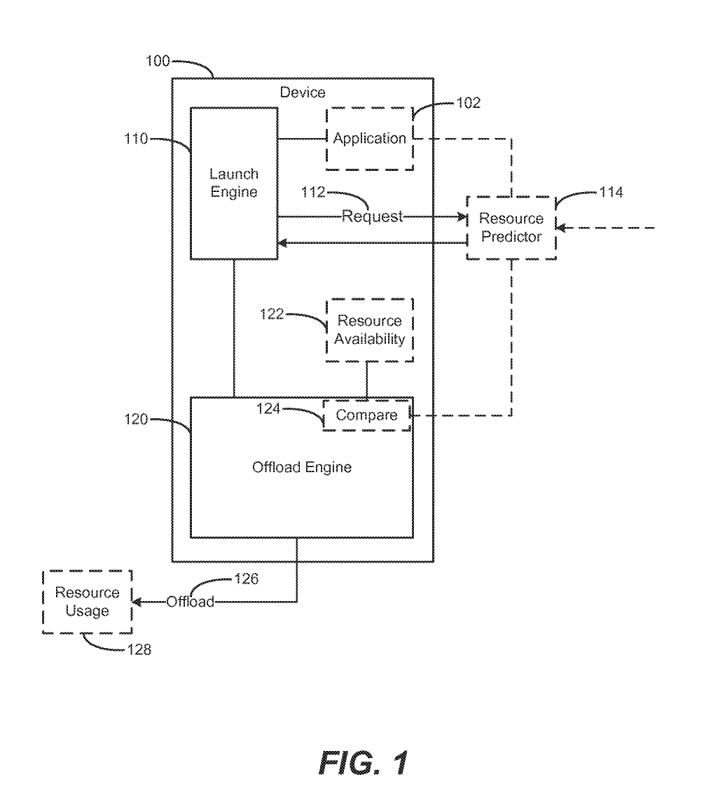

FIG. 1 is a block diagram of a device 100 including a launch engine 110 and an offload engine 120 according to an example. The launch engine 110 is to request 112 a resource predictor 114 indicative of predicted resource usage that is associated with execution of at least a portion of an application 102. The offload engine 120 is to identify resource availability 122 at the device 100, and compare 124 the resource availability 122 to the predicted resource usage as indicated in the resource predictor 114 for at least the portion of the application 102. The offload engine 120 may then offload 126, from the device 100, at least a portion of resource usage 128 of the application 102 responsive to the compare 124.

Application offloading may involve improving application execution and conserving energy on mobile devices, by leveraging resources in the cloud or other compute devices along with a better understanding of application resource usage. The launch engine 110 and the offload engine 120 may accomplish these and other goals by running on the device 100. As described herein, the term “engine” may include electronic circuitry for implementing functionality consistent with disclosed examples. For example, engines 110, 120 represent combinations of hardware devices (e.g., processor and/or memory) and programming to implement the functionality consistent with disclosed implementations. In examples, the programming for the engines may be processor-executable instructions stored on a non-transitory machine-readable storage media, and the hardware for the engines may include a processing resource to execute those instructions. An example system (e.g., a computing device), such as device 100, may include and/or receive the tangible non-transitory computer-readable media storing the set of computer-readable instructions. As used herein, the processor/processing resource may include one or a plurality of processors, such as in a parallel processing system, to execute the processor-executable instructions. The memory can include memory addressable by the processor for execution of computer-readable instructions. The computer-readable media can include volatile and/or non-volatile memory such as a random access memory (“RAM”), magnetic memory such as a hard disk, floppy disk, and/or tape memory, a solid state drive (“SSD”), flash memory, phase change memory, and so on.

The launch engine 110 can be directed (e.g., based on a profiling indication) to execute the application 102 with or without profiling enabled. In an example, the launch engine 110 may execute the application 102 with at least a portion of the application 102 instrumented, to profile that portion of the application 102 and collect information. Such collected information from the profiled application 102 may be used (e.g., by the device 100 and/or by a cloud server, not shown in FIG. 1) to develop the resource predictor 114 that may be used to decide whether offload 126. In an example, the launch engine 110 may be directed, e.g., by a user, to execute the application 102. At least a portion of the application 102 may already have been profiled, e.g., based on previously collected application execution and information collection (e.g., by the device 100 or other devices not shown in FIG. 1). The launch engine 110 may issue a request 112 for a resource predictor 114 for the application 102, in order to determine whether to offload 126 at least a portion of resource usage 128 associated with execution of the application 102. The resource predictor 114 may be device independent, regardless of a particular type of processor or other resource availability specifics that may have been used to generate the resource predictor 114 initially.

The resource predictor 114 may be based on analysis of collected resource usage information, e.g., obtained from the device 100 (e.g., during previous executions) and/or obtained from a plurality of other devices 100 (e.g., from other users who own other devices 100). The resource predictor 114 is based on a good understanding of the application 102, and is capable of estimating in a diverse way what are the different needs of the application 102 regarding resources of the device 100, such as compute (CPU), network, disk, etc. resource usage. The resource predictor 114 also may be independent of a specific application 102, such that the application 102 does not need to specifically be customized for allowing offloading. Thus, examples described herein enable a generic solution, which can apply to multiple applications without a need for the developer to customize the application. Further, examples can provide resource predictor 114 based on learning/observing from real users and the application traces that a real user generates during use of the application 102. For example, the resource predictor 114 may identify specifically what segments of a given application 102 are network intensive, what segments are disk intensive, what segments are CPU intensive, etc., to help in the offload 126 decision.

The offload engine 120 may intelligently compare 124 the resource predictor 114 to the resource availability 122 at the device 100. For example, the offload engine 120 may include services to identify the various capabilities of the device 100 directly, e.g., by observing the storage capacity, the CPU performance, the memory capacity, etc. Additionally, the offload engine 120 may identify resource availability 122 indirectly, e.g., by accessing a database of devices, identifying the specific device 100 on the database, and reading a list of performance attributes known for the device. Such resource availability 122 information also may be retrieved from a remote server or other source.

The offload engine 120 further may compare 124 the resource predictor 114 and resource availability 122 in view of predicted performance needs and impacts at the device 100. For example, if the device 100 is currently being used for another task that consumes CPU usage, the offload engine 120 may take into account the additional CPU burden and temporarily reduced CPU resource availability 122, and adjust the decision to offload 126 accordingly. Based on the compare 124, the offload engine 120 may then offload at least a portion of the resource usage 128 associated with the application 102.

For example, the offload engine 120 may identify a resource predictor 114 corresponding to at least a portion of the application 102 (e.g., disk I/O needs), compare 124 that with the resource availability 122 at the device 100, and correspondingly offload 126 at least a portion of resource usage 128 (e.g., resource usage 128 corresponding to disk I/O needs). Accordingly, examples described herein are not limited to offloading an entire application. In an example, the offload engine 120 may offload the portion of the application 102 corresponding to a function and/or method of the application 102. As used herein, a method of the application 102 may represent terminology corresponding to a type of function. The offload engine 120 may offload 126 a set of functions, e.g., a set that are grouped together in some manner by execution on the device 100. Thus, examples described herein may strategically target portions of an application 102 for offloading, without needing to profile, execute, and/or offload the entire application 102.

The resource availability 122 also may extend beyond the device 100. For example, a server (not shown in FIG. 1) may identify resource availability 122 at other devices, such as availability at a mobile tablet in proximity (e.g., via Bluetooth or within a local network), at a desktop computer, or at a cloud service/server. In an example, the offload engine 120 may avoid waste of disk I/O when running a facial recognition application 102 on a set of photos, by offloading the services to a laptop that may already have the photos stored on the laptop, instead of consuming disk I/O to upload all the photos from the device 100 to a cloud server that does not already have a copy of the photos to be analyzed by the application 102.

Thus, examples enable a Crowdsourcing-Based Application Profiler (CBAP) to make accurate offloading decisions. A crowdsourcing approach allows mobile devices to gather application execution usage information traces (including processing loads, network usage, memory and disk I/O usage), which may be processed (e.g., by a cloud device/server) to build the application profiles and corresponding resource predictors 114. Examples may minimize overhead at the mobile devices. For example, a device 100 may use an efficient application instrumentation technique, to capture the application traces to be used for generating the resource predictor 114. A device 100 may decide whether to instrument an application for collection of application traces according to a probabilistic distribution (e.g., as directed by a cloud device/server) and/or according to resource availability 122 at the device 100 itself (e.g., affecting how much of an impact the collection of application traces might cause at the device 100), thereby enabling devices 100 to avoid a need to carry the tracing overhead for application execution. Examples are adaptable, and may deploy adaptive critical information measurement mechanisms to avoid the imposing resource usage overhead caused by measuring application traces, if such information is unnecessary (e.g., if such information is already collected and sufficiently accumulated to develop sufficient resource predictors 114). Further, examples may use opportunistic sharing with the cloud/server of collected resource usage information, thereby enabling a given device 100 to conserve resources when needed, and share the collected usage information during times when device resource usage is not constrained. Thus, examples may use efficient crowdsourcing-based approaches to accurately profile applications, while minimizing the measurement overhead at the mobile device 100. The work of profiling the application 102 may be spread across a large number of devices 100 and executions of the application(s) 102, reducing the overhead experienced by a given device 100 and preserving good user experience. Profiles and corresponding resource predictors 114 are device independent, enabling data gathering and using the generated profiles/resource predictors 114 across heterogeneous devices and enabling accurate estimation of the effects of offloading 126 the resource usage 128 regardless of a specific type of the device 100. Offloading can ensure data security, by offloading to another device 100 of the user, without a need to upload data to the cloud.

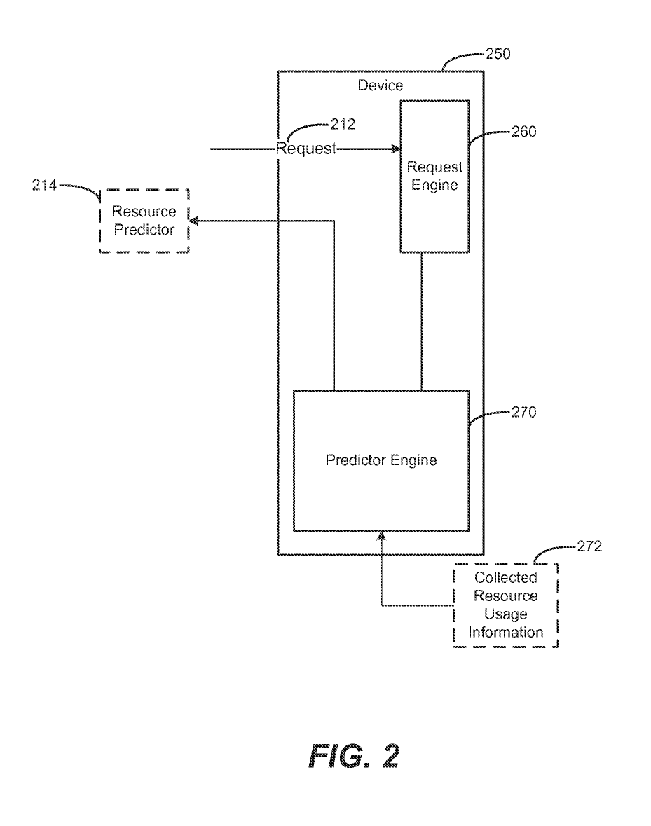

FIG. 2 is a block diagram of a device 200 including a request engine 260 and a predictor engine 270 according to an example. The request engine 260 is to receive a request 212 from a client device (e.g., device 100 shown in FIG. 1) indicating at least a portion of an application being executed. The predictor engine 270 is to generate a resource predictor 214 corresponding to predicted resource usage caused by execution of at least the portion of the application on the client device, based on analysis of collected resource usage information 272 obtained from a plurality of client devices.

The device 250 may be a cloud device (e.g., server), to build different application profiles in view of collected resource usage information 272 corresponding to those applications, which the predictor engine 270 may use to generate a corresponding resource predictor 214 for the applications. The predictor engine 270 may identify what aspects/portions of an application are to be measured in the future. Device 250 also may provide an application programming interface (API) to receive and service the requests 212 and/or any other interactions with other devices. For example, the device 250 may use an API to obtain a most recent profile of a given application, e.g., via collected resource usage information 272 and/or resource predictor 214. The device 250 may use a machine learning approach to analyze collected resource usage information 272 and/or generate the corresponding resource predictor 214.

The collected resource usage information 272 may be obtained in real-time from a currently executing application (e.g., at a client device, not shown in FIG. 2), and/or may be previously obtained (e.g., from that client device during previous application executions, and/or from other devices running that application). The device 250 may collect the collected resource usage information 272 from profile management services running on many different client devices (e.g., device 100 shown in FIG. 1) that generate resource usage information.

In an example, to profile a movie viewing application, a plurality of mobile client devices may upload, to the device 250, resource usage information associated with execution of the movie viewing application. The device 250 may accumulate such information as collected resource usage information 272, while taking into account the various different parameters, options, and usage scenarios spread across the various different runs of the application on the various client devices. The predictor engine 270 may analyze, estimate, and/or build one or more resource predictor(s) 214 indicating what would be the expected resource usage of the various different portions/functions/methods of the movie viewing application. The resource predictor 214 may be normalized to provide information applicable to a range of different client devices, scalable to their particular resource capabilities such as processing strength and memory size.

The predictor engine 270 may generate the resource predictor 214 based on aggregating and/or analyzing the collected resource usage information 272, such as by using machine-learning algorithms to generate the resource predictor 214. Further, the predictor engine 270 can use such analysis for other decisions, such as whether to instruct a client device to continue offloading at least a portion of a particular application.

Thus, device 250 may provide multiple services to client devices. It may identify what portion of an application that the client should instrument for profiling to collect the collected resource usage information 272, and whether to execute an application with such profiling enabled. The device 250 may gather the collected resource usage information 272 from the clients running an application, to understand and analyze the application and determine which portion to instrument in the future. Based on such information, the device 250 may build and send out the resource predictor 214 to the appropriate client device. Client devices may request 212 such resource predictors 214 as appropriate for various applications, to determine whether to offload at least a portion of that application to another device, or execute it locally on the client device.

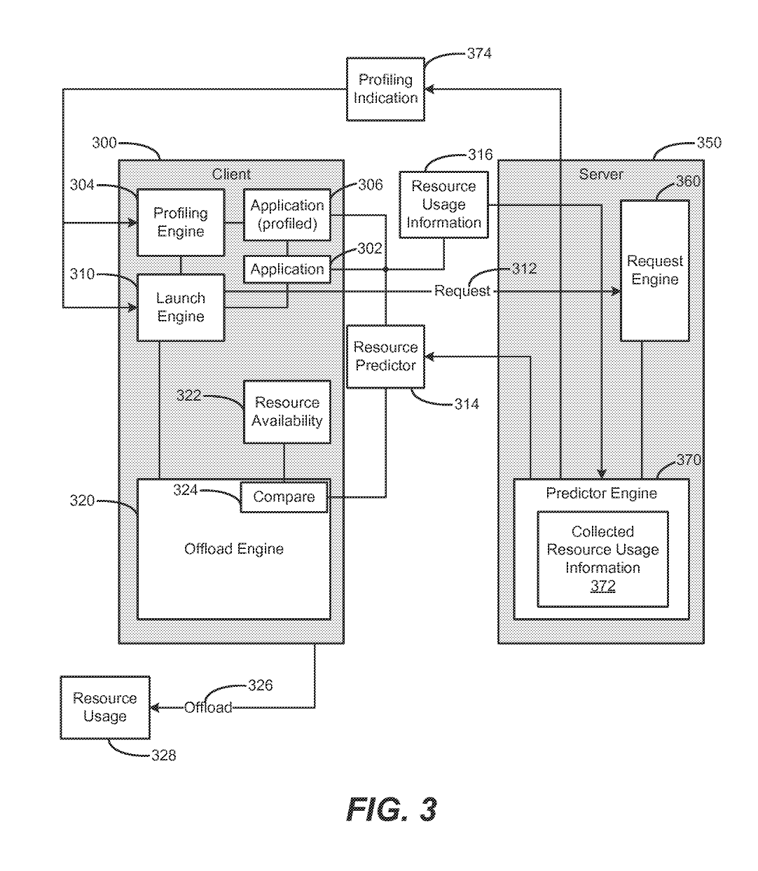

FIG. 3 is a block diagram of a client device 300 and a server device 350 according to an example. The client device 300 includes a profiling engine 304 and a launch engine 310 to launch and/or profile applications 302, 306, e.g., launch by a user of the client device 300, and/or profile in response to a profiling indication 374 from the server 350. The launch engine 310 may request 312 a resource predictor 314 from the server 350. The offload engine 320 may compare 324 the resource predictor 314 and the resource availability 322, and selectively offload 326 resource usage 328.

The server 350 includes a request engine 360 to receive requests 312 (e.g., to provide API services for resource predictors 314), and includes a predictor engine 370 to receive resource usage information 316 from client device(s) 300. The predictor engine 370 may accumulate and/or analyze collected resource usage information 372, and generate the resource predictor 314 and/or the profiling indication 374.

The client 300, upon executing an application 302, may profile merely a portion (e.g., a subset of functions) of the application 302 and execute it as profiled application 306, e.g., based on information contained in the profiling indication 374. The client 300 also may not even need to profile the application 302 at all, e.g., if the server 350 has already accumulated a sufficient/threshold amount of information regarding the application 302 (e.g., depending on what other profiled information has already been submitted by other executions of the application 302, e.g., by other clients 300). At least a portion of the application 302 may be instrumented, to provide profiled application 306 to log resource usage. Such resource usage information may be collected at the client device 300, and sent to the server 350.

The resource usage information 316 collected at the device 300 may be opportunistically compressed at the client device 300 and opportunistically shared with the server 350. For example, the resource usage information 316 may be handled according to resource availability 322 at the client 300, to take advantage of low-activity periods and/or to avoid over-burdening the client device 300 and/or degrading a user experience. More specifically, the client 300 may reduce the network footprint of uploading the resource usage information 316 measurements. Other aspects may be handled opportunistically, such as deferring upload when the device has a low battery, to wait for the device to be plugged in before uploading. Other conditions may be checked for opportunistic data transfer, such as whether the device is connected to a wireless network or third generation (3G) cellular data. The client 300 also may consider conditions associated with the server 350, e.g., if the server 350 is unreachable or busy, the client 300 may postpone the action.

The profiling engine 304 may perform profiling independent of offloading performed by the offload engine 320, e.g., in response to profiling indication 374 from the server 350 indicating what portion(s) of the application 302 the profiling engine 304 is to profile. For example, in response to a user selection of an application 302 to be executed, the launch engine 310 may decide whether to execute the normal application 302, or a profiled version of the application 306 that has been instrumented for collection of resource usage information 316. Even execution of the normal application 302 may generate resource usage information 316 (e.g., collection of trace information, corresponding to attributes of at least a portion of the application invoked by execution of the application, and measurement information corresponding to attributes of resources used by execution of the application). The profiling engine 304, independent of the offload engine 320, enables collection of resource usage information 316 to enable the offload engine 320 to make informed and accurate decisions whether to offload 326 resource usage 328 off the client 300.

By crowdsourcing collection of the resource usage information 316 across various different clients 300, the resource usage information 316 reflects actual real-world usage scenarios of a given application 302/306, in contrast to a simulator collecting data from randomly simulated user inputs. Furthermore, the profiling engine 304 and the launch engine 310 can ensure that the user experience of interacting with the client 300 is not negatively impacted (e.g., not abnormally slowed down due to the act of profiling and collecting resource usage information 316). Crowdsourcing frees a given client 300 from needing to profile the entire application 302, thereby avoiding any significant slow-downs to the application 302 (although, in examples, the entire application 306 may be profiled, e.g., according to resource availability 322 and usage scenarios). Further, the server 350 may use profiling indications 374 to direct a given client 300 to profile various portions of the application 302, thereby allowing the profiling to be spread across many clients 300 with a negligible impact to each client 300. The server 350 may probabilistically distribute such selective profiling across a pool of client devices 300 and/or across time for a given client device 300, avoiding any negative impacts to performance at the client 300.

In an example, a mobile device client 300 may be running the Android™ operating system or other mobile operating system. The client 300 may be a mobile device such as a smartphone, tablet, laptop, or any other type of application platform. The launch engine 310 may run on the application platform of the client 300 to intercept application launching, and similarly the profiling engine 304 may run on the application platform to perform instrumentation and/or selective profiling to at least a portion of the application 306.

The profiling engine 304 may instrument applications 302, to log their resource usage as profiled applications 306, without needing access to the application's source code. In some examples, the application 302 may be based on the Android™ operating system, which may use kernel routines for interpreting/compiling application binaries, to instrument the application 302 after checking its signature. Accordingly, the profiling engine 304 is not tied to any particular application, and applications 302 do not need to be specifically modified to be suitable to the profiling engine 304. The profiling engine 304 may use code insertion to modify selected functions/methods of a target application 302 to be instrumented for profiling. Thus, the profiling engine 304 may target just a portion (e.g., function(s)/method(s)) of the application 302 for instrumenting, ensuring a low overhead compared to full application instrumenting. The profiled application 306 may include the inserted code to measure various resource usage information 316, such as the compute, I/O, and network usage of the functions/methods of the profiled application 306. The measurements obtained from the profiled application 306 may be stored at the client 300 so that they can be processed (e.g., compressed) before transmitting the profiled information (resource usage information 316) to the server 350 and/or a cloud service/engine, where the resource usage information 316 also may be stored and/or processed.

The profiling engine 304 may make intelligent decisions as to which portion(s) of the application 302 to profile. For example, the client 300 may identify usage patterns related to network I/O, and decide to instrument the network access functions/methods of the application 302. The profiling engine 304 also may decide what portion(s) of the application 302 to profile based on indications received from the cloud/server 350, e.g., based on profiling indication 374. For example, the server 350 may analyze collected resource usage information 372 indicating heavy CPU usage, and provide profiling indication 374 indicating to the profiling engine 304 of client 300 that the CPU-heavy methods/functions of the application 302 should be profiled/instrumented.

The profiling engine 304 may accomplish the instrumentation/profiling of the application 302 based on code insertion. Thus, it is not needed for an application developer to modify or annotate a given application to specifically/manually demark a function as heavy or light (or other manual characterization of how the application would behave). In contrast, examples described herein may interact with any application, even without having access to the source code of that application 302, because it is not needed to performing the profiling at the development stage of the application 302. In some examples, the application 302 may be a java byte code application, which may be modified for application instrumentation based on code injection. Thus, at different points in the execution of the application 302, various different performance metrics may be logged, after the application has been published. Similarly, Android-based applications are accessible via use of byte code interpretation to use code injection for profiling, as well as for identifying which resources are used (e.g., enabling collection of trace information and/or measurement information).

The profiling engine 304 thus enables generation of the resource usage information 316, which may be used to generate profiling indication 374. Such information may be used to inform the launch engine 310, which may read the resource usage information 316 and/or the profiling indication 374. The launch engine 310 may then identify whether to execute the basic application 302 with no profiling, or execute the application with at least a portion of the application profiled 306. Execution of the application 302 and/or the profiled application 306 enables the client 300 to generate information that may be recorded in log files (e.g., resource usage information 316, including trace and/or measurement information). Such information may include aspects such as what time a particular function was called, what CPU cycles were used, what network calls were issued, what network sockets were opened, how many bytes of data were transmitted, and so on. More specifically, resource usage information 316 may include measurements and traces. The measurements include metrics such as the CPU/disk usage and so on. The traces include metrics such as what functions were called, what where the argument types that were called, what process/thread was instantiated, what was the timestamp, or other details in terms of what was the Application 1D that was launched and so on. Such information may be collected, even if a given application 302 is not profiled at all. Such information may be stored as log files on the client 300, and/or uploaded to the server 350 as resource usage information 316. The resource usage information 316 may be sent periodically, e.g., after being opportunistically compressed on the client 300. The predictor engine 370 of the server 350 may process the resource usage information 316 to create resource predictors 314. The profiling engine 304 may tag the collected resource usage information 316 with an identifier, such as an application's universally unique identifier (UUID), yet another type of measurement trace.

The resource usage information 316 may include the following values for a function of a running application: Thread ID in the running instance: (p_{id}, th_{id}); Function identification fᵢ; Function signature: Arguments type and size, i.e. {Arg_{fi,1}, Arg_{fi,2}, Arg_{fi,3}, . . . }, and return type and size i.e. {Ret_{fi,1}, Ret_{fi,2}, Ret_{fi,3}, . . . }; Execution duration: Timestamp of each function invocation T_invoke and return T_return_{fi}; Resource usage: where the predictor engine 370 logs device-independent resource usage of each function as the execution duration of each function may depend on the device hardware capabilities. Thus, CPU usage of fᵢ may be measured in terms of CPU cycles CPU_{fi} on an advanced reduced instruction set computing (RISC) machine (ARM) processor. This can be achieved by reading CPU cycle counter registers periodically. Additionally, network usage may be measured as bytes transferred over a network NW_{fi}, and I/O requirements may be measured as bytes read/written on disk Disk_{fi}. Such device-independent measurements allow the information from mobile clients with diverse hardware to be combined in the cloud engine, to generate information that is invariant between dissimilar devices.

Furthermore, the resource usage information 316 and/or the resource predictor 314 may be normalized to be relevant to any type of devices 300. For example, network and disk usage may be expressed in bytes, and can be compared across different devices. The CPU usage/consumption may be expressed as a unit that is invariant across different devices (e.g., regardless of how powerful a given device's CPU may be), such as in terms of megaflops. The normalized CPU usage needs may be translated to predict an effect of how fast a given device may execute a function/method/application. Such CPU usage may be mapped to a CPU load (e.g., CPU percentage) to be expected on a given device 300. Other metrics may similarly be normalized. By normalizing across and between different devices, various examples described herein may accurately predict the effect of a given application to be executed on a given device 300. For example, the resource predictor 314 may predict the performance effect of a given application to be executed on a given device, in view of the normalized metrics gathered by the server 350.

The launch engine 310 may probabilistically execute applications (the instrumented application 306 and/or the normal application 302), to minimize profiling overhead on a given device 300. The client 300 may identify conditions at the client 300 that are favorable to executing a profiled application 306 to minimize profiling overhead. The launch engine 310 also may identify whether to execute the normal application 302 and/or the profiled application 306 in response to the profiling indication 374. For example, the predictor engine 370 of the server 350 may determine a probability across a plurality of clients 300 for which the application should run with profiling enabled or disabled. For example, the predictor engine 370 may identify a need for 10% of client devices 300 to execute the profiled application 306 to collect relevant data, and instruct every tenth client 300 to run the profiled application 306. Alternatively, the profiling indication 374 may instruct clients 300 to execute profiled application 306, where one tenth of the methods/functions of the profiled application 306 are profiled (thereby obtaining a 10% profiling coverage). The desired probability may be based on the confidence of the predictor engine 370 in the sample set of collected resource usage information 372 that has been collected at the predictor engine 370. Thus, the probabilistic execution of applications may apply to whether a device 300 is to execute the original/normal application 302, or the modified/profiled application 306 as instrumented by the profiling engine 304, and/or may apply to what degree a given application is profiled/instrumented. Furthermore, the predictor engine 370 may instruct clients 300 whether to execute normal/profiled applications 302/306 based on whether the predictor engine 370 sends a resource predictor 314 or not. For example, if ten clients 300 request 312 a resource predictor 314, the predictor engine 370 may achieve a 50% probabilistic profiling result by sending the resource predictor 314 to five of the ten clients 300, without responding to the remaining five. A similar approach (whether to even respond with the resource predictor 314) may be applied to whether to offload 326 resource usage 328, e.g., by declining to respond with a resource predictor 314 to those clients 300 on which offloading 326 is deemed not appropriate.

To determine the potential impact of executing a given application 302 on a given device 300, the launch engine 310 may issue the request 312 to the request engine 360 of the server 350, to request the resource predictor 314. The request 312 also may be sent from, and/or on behalf of, the profiling engine 304. In response to the profiling engine 304 identifying whether to make an offloading decision, it may request what the current resource predictors 314 are (relevant to a given application(s) to be executed), to identify the estimated resource usage (CPU usage, disk usage, etc.) of a given function. The device 300 may then instruct the offload engine 320 as to whether to offload 326 given resource usage 328 of an application, or run it locally.

The server 350 may respond to the client 300 request 312, by providing profiling indications 374 and/or resource predictors 314. The predictor engine 370 may receive resource usage information 316, such as a chronological log of function(s) called during an execution instance of an application 302/306. The predictor engine 370 may combine different user traces/resource usage information 316, processing the collected resource usage information 372, and perform machine learning methods to service clients 300 that may request resource predictors 314 to assist in determinations to offload 326 resource usage 328.

The predictor engine 370 may build the function resource predictor 314, determine future profiling decisions, and provide an API for clients 300 to request application resource predictors 314. The predictor engine 370 may accumulate data on various applications/functions/methods and/or collected resource usage information 372. In some examples, after profiling a given application 306 and collecting sufficient resource usage information 316 to provide accurate predictors, the predictor engine 370 may instruct the client 300 to cease collecting resource usage information 316 for that application 302/306. Such communication from the predictor engine 370 may be carried by the profiling indication 374 (which may include indications to stop profiling). Accordingly, the predictor engine 370 enables conservation of resources, reducing the potential impact on user experience at the client 300.

The predictor engine 370 may take into account a given condition of the client 300 (e.g., as indicated in trace/measurement resource usage information 316) when providing resource predictor 314. The predictor engine 370 may use machine learning techniques to improve accuracy of the resource predictor 314, e.g., by inferring an effect on one client 300 based on accumulated information across other similar clients 300. The predictor engine 370 may provide such predictions at a fine level of granularity, e.g., specific to a given application that is running a particular method/function during a particular state of the client device 300. The resource predictor 314 may indicate that such a condition would result in, e.g., the client 300 needing a given amount of network and CPU bandwidth, which currently may not be available at the client device 300, thereby instructing the client 300 to offload 326 such resource usage 328 to another device or to the cloud.

In a more specific example, the predictor engine 370 may build the resource predictor 314 as follows. For a given function fₖ with N samples, the predictor engine is to consider the following sample set: CPU cycles for each run CPU_{fi,j}, ∀jε[1,N]; Bytes transferred over network for each run NW_{fk,j}, ∀jε[1,N]; Bytes read/written on disk Disk_{fk,j}, ∀jε[1,N]; Resource usage history (CPU_{fp,q}, NW_{fp,q}, Disk_{fp,q}) of any function fₚ called at most three function calls before fₖ in the q^{th} log. Let LastCalled_{fk} denote the set of all (fₚ,q) called at most three function calls before fₖ, for all runs qε[1,N]; Input parameters: {Arg_{fi,1,q}, Arg_{fi,2,q}, Arg_{fi,3,q}, . . . } for all runs qε[1,N]. The predictor engine 370 may generate the resource predictor 314 using a linear predictor, e.g., based on machine learning, as follows. In an example, the above listed features are used by the predictor engine 370 to build a linear predictor for a resource requirement of fₖ. In an example, the machine learning may be based on an off-the-shelf support vector machine (SVM) technique, to define predictors for CPU, network, I/O, memory, disk, etc. requirements of each application method/function, by learning the coefficients for each feature listed above. For example, a CPU predictor may be defined as:

$$Predict {CPU}_{fk} = {a}_{0} + {\sum }_{j = 1}^{j = N} ( {a}_{j} * {CPU}_{fk , j} ) + {\sum }_{j = 1}^{j = N} ( {b}_{j} * {NW}_{fk , j} ) + {\sum }_{j = 1}^{j = N} ( {c}_{j} * {Disk}_{fk , j} ) + {\sum }_{{f}_{p} , q ∈ {LastCalled}_{{f}_{k}}}^{ } ( {d}_{{f}_{p} , q} * {CPU}_{fp , q} , {NW}_{fp , q} , {Disk}_{fp , q} ) , \\ where \{ {a}_{0} , {a}_{1} , … , {a}_{N} \} , \{ {b}_{0} , {b}_{1} , … , {b}_{N} \} , \{ {c}_{0} , {c}_{1} , … , {c}_{N} \} , \\ and \{ {d}_{{f}_{p} , q} \vert ( {f}_{p} , q ) ∈ {LastCalled}_{fk} \}$$

are estimated using the SVM.

The predictor engine 370 may compare the execution time of PredictCPU_{fk} with the median execution time of fₖ. If the execution overhead of PredictCPU_{fk} is less than, e.g., 10% of the execution time of fₖ, then the predictor engine 370 may share the resource predictor 314 with the respective client 300. Other percentages/thresholds may be used in alternate examples, as appropriate. At the client 300, the offloading engine 320 may use the resource predictor 314 during future runs of the application 302/306. For example, before executing a function of the application 302/306, the offload engine 320 may estimate its resource requirements. If the predicted resource requirements are within the acceptable limits, the offload engine 320 may instruct the client 300 to execute the function locally. Otherwise, the function (e.g., resource usage 328) is offloaded to a remote device/cloud. In an example, for functions where the predictor indicates more than a 10% resource usage overhead (e.g., execution time), the predictor engine 370 may decline to share the resource predictor 314 with the requesting client 300. The predictor engine 370 may apply this or other criteria for other resource predictors 314 for a given function fₖ, aiding run time decisions for other resources as needed.

Thus, the above examples illustrate generation of and usage of an example resource predictor 314. The resource predictor 314 may therefore take into account a current state of the client device 300 and/or the server 350, in view of the collected resource usage information 372, to identify the set of coefficients to various different parameters to estimate resource usage for a function/method/application.

Such analysis may be applied to future profiling decisions. As the predictor engine 370 collects measurement traces and other collected resource usage information 372 for a function/method/application, it may determine confidence levels in the sample set of collected information. For example, the predictor engine 370 may identify a confidence level in the collected resource usage information 372 being at or above a threshold (e.g., 90%), at which point the predictor engine 370 may instruct the clients 300 to stop profiling the particular function or an entire application pertaining to the threshold. The predictor engine 370 also may consider the overhead of the resource predictor functions that are created by the machine learning/SVM. For example, if the overhead at the client 300 of implementing the resource predictor 314 is at or above a given threshold (e.g., 10%) of the application execution time at the client 300, the predictor engine 370 may instruct the client 300 to stop profiling the function/application (alternatively, the client 300 itself may monitor such threshold on client overhead).

The server 350 may provide an API, e.g., to service requests 312 and provide responses thereto. The predictor engine 370 may interact with the request engine 360 (which may be incorporated into the predictor engine 370) to handle interactions with the API offered by the server 370 for enabling requests 312 for resource predictors 314 for a variety of offloading systems. The API may serve as an interface to the predictor engine 370 and/or the offload engine 320. Offload engines 320 from various different client devices 300 may request the resource predictors 314 from the predictor engine 370, which may respond through the API. Alternate examples may provide the various functionality directly, without specifically using an API.

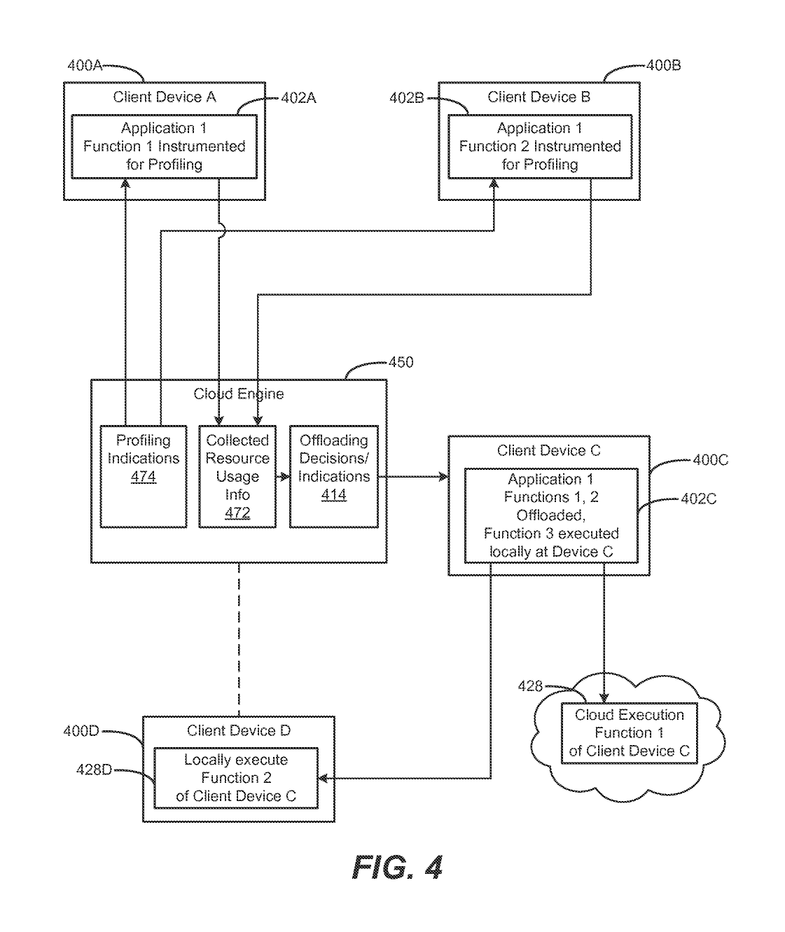

FIG. 4 is a block diagram of a plurality of client devices 400A, 400B, 400C, 400D and a cloud engine 450 according to an example. Client device A 400A includes application status 402A corresponding to application 1 with function 1 instrumented for profiling, and client device B 400B includes application status 402B corresponding to application 1 with function 2 instrumented for profiling. The portions of the applications are instrumented/profiled according to profiling indications 474 from the cloud engine 450, to provide collected resource usage information 472 to the cloud engine 450. The cloud engine 450 is to provide offloading decisions/indications 414, e.g., to client device C 400C. Thus, the application status 402C corresponds to application 1 with functions 1 and 2 offloaded, and function 3 executed locally at client device C 400C. Thus, function 1 of client device C 400C is offloaded to cloud execution 428, and function 2 of client device C 400C is offloaded to client device D 400D, based on local execution 428D of function 2 at client device D 400D.

Cloud execution 428 may represent execution of at least a portion of an application on another device, such as a server or collection of servers or cloud services. Cloud execution 428 also may represent execution on other client devices, such as those devices on a user's personal cloud (e.g., other devices sharing the user's local network).

The various elements/devices illustrated in FIG. 4 may run services, to enable a given device to be visible to the cloud engine 450 and other devices. Such services may be network communication interfaces, to enable offloading to a device, and enable a device to send/receive commands and instructions from the different elements/devices, to offload portions of the applications to the various other device(s) (including the local device(s)). Such network communication functionality is to enable devices to be aware of other devices for offloading on the same network, e.g., in proximity to the device that is to offload.

In an example, the client device 400C is to execute a face recognition photo application 402C having three functions 1-3. A user owns client device 400C (a tablet mobile device) and client device 400D (a desktop computing device). Photo albums to be analyzed are contained in a cloud account and mirrored on client device 400D, but the user is executing the face recognition application on client device 400C. The cloud engine 450 may be executed on a cloud server (in alternate examples, may be executed on a local device), and may collect resource usage information 472 from other client devices 400A, 400B regarding functions 1 and 2. Thus, the cloud engine may analyze the collected resource usage information 472 and generate offloading indications 414 for functions 1 and 2 (e.g., recognizing human faces, and disk usage to access the photos). Accordingly, the client device 400C, instead of downloading the photos from the cloud or the client device 400D, may offload function 2 428D to the client device 400D, thereby avoiding a need to re-download the photos that are already stored on the client device 400D. In an alternate example, the client device 400C may offload the photo download network usage to cloud execution 428 (e.g., having the photos downloaded to a cloud server, or fetched from one storage cloud to another processing cloud, that is capable of analyzing and processing those photos on the cloud, without needing to download them to the client device 400C). Such offloading of network access results in drastically less traffic sent to the client device 400C, in view of the actual image data and offloading taking place in the cloud instead of the client device 400C. Thus, in situations when a user is accessing information via cellular network, the user may avoid substantial network access costs.

The cloud engine 450 may be aware of other devices 400A-400D and 428 and send profiling indications 474 and collect information 472 regarding such devices, to become aware of available services and files on various device (such as identifying that the user's desktop computer 400D contained a copy of the photos to be analyzed). Thus, the cloud engine 450 can inform the tablet client device 400C to offload the photo disk access to the desktop device 400D to avoid time delays that would otherwise be involved in transferring the photos from the desktop to the tablet. Network communication functionality at the devices enables cloud-based management of devices of a user across locations/networks, such as laptop, tablet, smartphone, and other devices associated with the user. Aspects of such devices may be used in determining whether to offload computations/functionality between devices, such as offloading resource usage from a smart phone with a low battery to a tablet that has more battery life and/or the pertinent data. Further, offloading among a user's devices enables the user to enjoy the power of cloud computing while maintaining the security of user data, without needing to upload data to a 3^{rd} party cloud or other server that is not under the user's control.

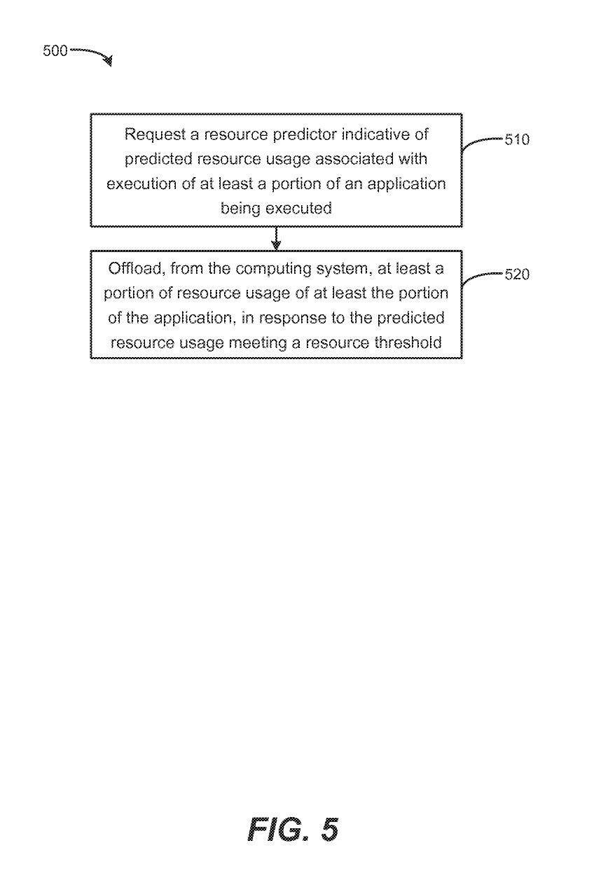

Referring to FIGS. 5-7, flow diagrams are illustrated in accordance with various examples of the present disclosure. The flow diagrams represent processes that may be utilized in conjunction with various systems and devices as discussed with reference to the preceding figures. While illustrated in a particular order, the disclosure is not intended to be so limited. Rather, it is expressly contemplated that various processes may occur in different orders and/or simultaneously with other processes than those illustrated.

FIG. 5 is a flow chart 500 based on offloading resource usage according to an example. Although FIG. 5 refers to an application and a computing system, such features may refer to other portions of applications and devices and/or cloud services. In block 510, a resource predictor is requested, indicative of predicted resource usage associated with execution of at least a portion of an application being executed. For example, in response to a user of a computing system executing a function of an application, the computing system may request a resource predictor to identify what impact the function will have on the system. In block 520, at least a portion of resource usage of at least the portion of the application is offloaded from the computing system in response to the predicted resource usage meeting a resource threshold. For example, the resource predictor requested by the computing system may identify that execution of the function may exceed 10% of the available resources at the computing system, such that the computing system should offload execution of that function. The various techniques of blocks 510 and 520 do not need to be performed in sequence as illustrated. In alternate examples, the illustrated techniques may be performed in parallel, in alternate order, or as a background/deferred process. Furthermore, the resource predictor of block 510 may be based on profiling techniques accomplished as set forth above, e.g., based on collecting and analyzing resource usage information associated with the application/function.

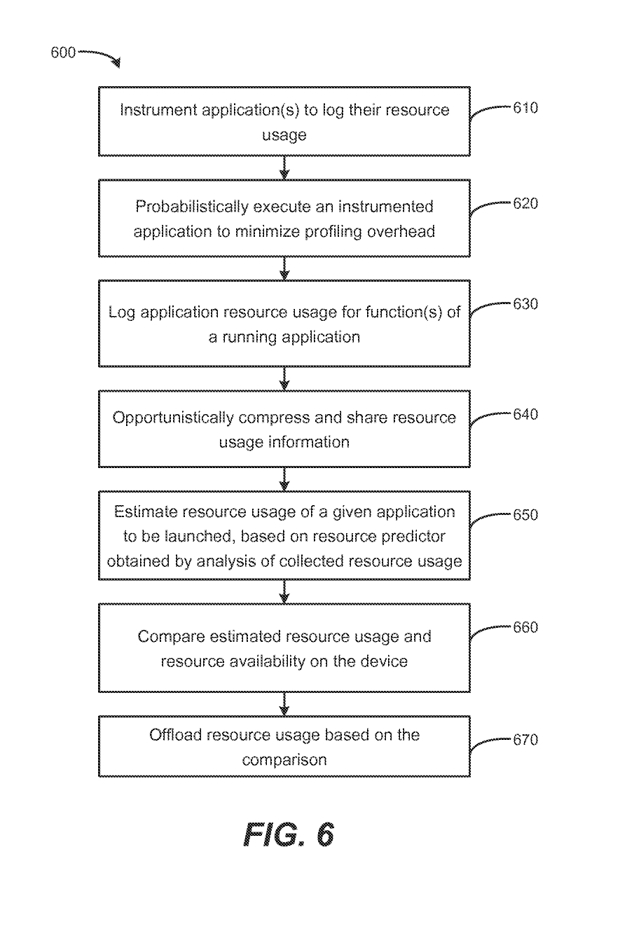

FIG. 6 is a flow chart 600 based on offloading resource usage according to an example. The features of FIG. 6 are not limited to an application and a computing system, and may refer to other portions of application, devices, and/or cloud services etc. In block 610, application(s) are instrumented to log their resource usage. For example, code insertion may be used to track and collect information on CPU resource usage of an instrumented application function. In block 620, an instrumented application is probabilistically executed to minimize profiling overhead. For example, a server may instruct, via a profiling indication selectively issued across devices probabilistically, whether a given device should execute a normal application function or the instrumented application function. In block 630, application resource usage is logged for function(s) of a running application. For example, the device may track CPU usage in terms of fractions of megaflops consumed by the instrumented application function on the device. In block 640, resource usage information is opportunistically compressed and shared. For example, the device may collect the usage information, and identify periods of light use where the device's resources are available to compress the data and send out the data, without negatively impacting user experience. In block 650, resource usage of a given application to be launched is estimated, based on a resource predictor obtained by analysis of collected resource usage. For example, a predictor engine of a server may generate a resource predictor relevant to an executed application function, based on collected resource usage information that may have been collected by earlier executions of the application and/or executions on other devices whose performance has been normalized for relevancy to the present device. In block 660, estimated resource usage and resource availability on the device are compared. For example, an offload engine of the client device may check for its available resources according to a present device state, and compare to what resources would be consumed by execution of the application function according to the resource predictor. In block 670, resource usage is offloaded based on the comparison. For example, the offload engine may identify that the resource predictor indicates that the executed application function would exceed a threshold usage of resources given the device's current state. The device may then pass resource usage on to another device (such as another client device or server or cloud services etc.). The various techniques of blocks 610-670 do not need to be performed in sequence as illustrated. In alternate examples, the illustrated techniques may be performed in parallel, in alternate order, or as a background/deferred process.

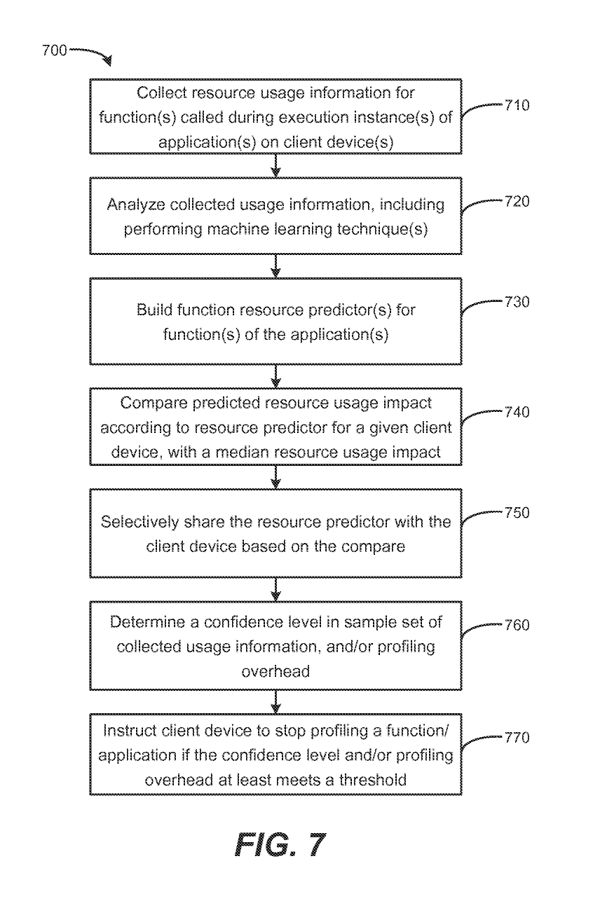

FIG. 7 is a flow chart 700 based on building resource predictor(s) according to an example. The features of FIG. 7 are not limited to an application and a computing system, and may refer to other portions of application, devices, and/or cloud services etc. In block 710, resource usage information is collected for function(s) called during execution instance(s) of application(s) on client device(s). For example, a server may collect resource usage information that is generated by instrumented applications that are executed on various client devices. In block 720, collected usage information is analyzed, including performing machine learning technique(s). For example, the server may perform linear analysis on data collected from various different devices, and normalize the data to be representative across devices (meaningful data that is device invariant). In block 730, function resource predictor(s) are built for function(s) of the application(s). For example, a given function may be associated with consumption of a given number of computing megaflops, which would generally apply across different devices and CPUs independent of their particular computing power. In block 740, predicted resource usage impact according to resource predictor for a given client device is compared with a median resource usage impact. For example, a device may be associated with a threshold or average level of impact that is deemed tolerable for user experience, and the resource predictor may be checked against such a threshold to enable a client device's offload engine to determine whether to offload a given application function. In block 750, the resource predictor is selectively shared with the client device based on the compare. For example, a predictor engine of a server device may identify that the predicted impact of an application function would exceed the threshold on a first device, and send the resource predictor to the first device to enable the first device to offload the application function. In contrast, the server device may predict that the impact would not exceed the threshold on a second device, and therefore decline to share the resource predictor with the second device (which would therefore execute the application function locally without negatively impacting a user experience at that device). In block 760, a confidence level in sample set of collected usage information, and/or profiling overhead, is determined. For example, the predictor engine of a server device may analyze collected resource usage information, and determine that the information is sufficient for normalizing performance impact predictions across a variety of devices exposed to the server (e.g., accessible via API). In block 770, the client device is instructed to stop profiling a function/application if the confidence level and/or profiling overhead at least meets a threshold. For example, the predictor engine of the server may send a profiling indication to a client device, instructing the client device to cease profiling a given application function (e.g., execute the normal application/function, instead of the instrumented/profiled application/function). The various techniques of blocks 710-770 do not need to be performed in sequence as illustrated. In alternate examples, the illustrated techniques may be performed in parallel, in alternate order, or as a background/deferred process.

Examples provided herein may be implemented in hardware, software, or a combination of both. Example systems can include a processor and memory resources for executing instructions stored in a tangible non-transitory medium (e.g., volatile memory, non-volatile memory, and/or computer readable media). Non-transitory computer-readable medium can be tangible and have computer-readable instructions stored thereon that are executable by a processor to implement examples according to the present disclosure.

An example system (e.g., a computing device) can include and/or receive a tangible non-transitory computer-readable medium storing a set of computer-readable instructions (e.g., software). As used herein, the processor can include one or a plurality of processors such as in a parallel processing system. The memory can include memory addressable by the processor for execution of computer readable instructions. The computer readable medium can include volatile and/or non-volatile memory such as a random access memory (“RAM”), magnetic memory such as a hard disk, floppy disk, and/or tape memory, a solid state drive (“SSD”), flash memory, phase change memory, and so on.

What is claimed is:

1. A device comprising:
a launch engine to, in response to an application being executed, request a resource predictor indicative of predicted resource usage associated with execution of at least a portion of the application, wherein the resource predictor is based on analysis of collected resource usage information; and
an offload engine to identify resource availability at the device, compare the resource availability to the predicted resource usage as indicated in the resource predictor for at least the portion of the application, and offload, from the device, at least a portion of resource usage of the application responsive to the compare.

2. The device of claim 1, wherein the launch engine is to receive a profiling indication, and execute an application with profiling selectively enabled according to the profiling indication, to enable collection of resource usage information associated with execution of at least a portion of the application.

3. The device of claim 2, further comprising a profiling engine to instrument at least a portion of the application, to collect resource usage information for at least the portion of the application according to the profiling indication.

4. The device of claim 3, wherein the profiling engine is to instrument the application based on using code injection to modify at least the portion of the application, enabling a reduced impact to resource usage for the instrumented application, compared to full application instrumenting.

5. The device of claim 3, wherein the profiling engine is to identify an impact to resource usage for the instrumented application, and determine to what degree the application is to be instrumented and profiled, to maintain a satisfactory user experience associated with execution of the instrumented application.

6. The device of claim 2, wherein the resource usage information includes at least one of i) trace information, corresponding to attributes of at least a portion of the application invoked by execution of the application, and ii) measurement information corresponding to attributes of resources used by execution of the application.

7. The device of claim 6, wherein the measurement information includes at least one of a) compute usage, b) memory usage, c) storage input/output (I/O) usage, and d) network usage.

8. The device of claim 6, wherein the measurement information is normalized to remain invariant between dissimilar devices to enable accurate estimation of an offloading effect for that measurement information for a given device.

9. A device comprising:
a request engine to receive a request from a client device indicating at least a portion of an application being executed; and
a predictor engine to generate a resource predictor corresponding to predicted resource usage caused by execution of at least the portion of the application on the client device, based on analysis of collected resource usage information obtained from a plurality of client devices.

10. The device of claim 9, wherein the predictor engine is to generate a profiling indication to indicate whether to enable profiling by a launching engine of a given client device, wherein the indication is based on probabilistically distributing profiling of the application across a plurality of client devices to reduce profiling overhead at the given client device.

11. The device of claim 10, wherein the predictor engine is to generate the profiling indication to indicate that profiling is to not be enabled, based on meeting a confidence threshold of aggregated and analyzed resource usage information collected for at least the portion of the application.

12. The device of claim 9, wherein the predictor engine is to identify predicted resource usage for the client device, and decline to send the resource predictor to the client device in response to the predicted resource usage at least meeting a performance impact threshold.

13. The device of claim 9, wherein the predictor engine is to generate the resource predictor based on a linear predictor according to support vector machine techniques.

14. A non-transitory machine-readable storage medium encoded with instructions executable by a computing system that, when executed, cause the computing system to:
request a resource predictor indicative of predicted resource usage associated with execution of at least a portion of an application being executed; and
offload, from the computing system, at least a portion of resource usage of at least the portion of the application, in response to the predicted resource usage meeting a resource threshold.

15. The storage medium of claim 13, further comprising instructions that cause the computing system to receive a profiling indication, and instrument at least a portion of the application, to collect resource usage information associated with execution of at least the portion of the application according to the profiling indication.
